(19) United States
(12) Patent Application Publication
(10) Pub. No.: US 2022/0335918 A1
(43) Pub. Date: Oct. 20, 2022

(54) Adaptive Acoustical Treatment with Magnetic Coupling

(71) Applicant: Acoustical Fulfillment LLC, Forked River, NJ (US)

(72) Inventors: Gavin A. Haverstick, Indianapolis, IN (US); Katherine C. Cardwell, Parkville, MD (US); Garnett J. Callis, Lanoka Harbor, NJ (US)

(21) Appl. No.: 17/235,406

(22) Filed: Apr. 20, 2021

(51) Int. Cl. G10K 11/162; G10K 11/20

(52) U.S. Cl. CPC G10K 11/162; G10K 11/20

(57) ABSTRACT

An acoustical treatment assembly includes an absorption panel and a diffusion panel that may be removably mounted to the absorption panel. The absorption panel has a first surface, an opposite second surface and a plurality of edge surfaces. The absorption panel has channels defined in either or both of the second surface and the edge surfaces. Each channel has a seat spaced apart from the first surface and the second surface, in which is disposed a magnet. The diffusion panel has a first surface, a second surface and a plurality of interior openings extend from and through the first surface and the second surface. The diffusion panel is formed of a material having a lower audio absorption than the absorption panel. Additional magnets are mounted on the diffusion panel that cooperate with magnets of the absorption panel to removably retain the diffusion panel adjacent to the absorption panel.

### FIELD OF THE INVENTION

The present invention relates generally to acoustical treatments for architectural spaces.

### BACKGROUND OF THE INVENTION

Acoustical treatment has been used to enhance the acoustic quality of architectural spaces such as rooms and halls. Acoustical treatment is useful and largely necessary in both venues in which music is publicly performed, and in studios or other venues where music is recorded or even practiced. Without acoustical treatment, echoes, reverberation and other reflective features of venues can adversely affect the desired qualities of the sound.

A common form of acoustical treatment involves absorption. Absorption removes some or most of the undesired reverb or echo caused in venues with acoustically reflective walls. To this end, foam, fiberglass or other acoustically absorbent panels or devices are often disposed within the room at places where sound reflection is prevalent. Such absorbent panels operate to “deaden” the acoustic properties of the room.

Another type of acoustical treatment includes diffusion properties. Sound diffusers are devices or systems that reflect and scatter incident sound waves to that the energy of the waves is diffused in many directions, as opposed to being concentrated. For example, the undesirable echo effects in rooms with large flat walls are caused by concentrated zones of reflected sound. Sound diffusers are shaped to reflect the sound in various directions to avoid or reduce concentrations. Because diffusers reflect sound, as opposed to absorbing sound, the sound is not deadened to the same degree, and high frequency energy is retained.

Still other acoustic treatments incorporate aspects of both absorption and diffusion. Such devices typically have a diffusive material covering, but with openings, an absorptive material. For example, it is known to use a wooden panel mounted to an absorptive panel. The wooden panel can have many slots or openings of different shapes, which both affect the diffusive properties, and allow for some quantity of absorption.

Currently, studios and performance halls must essentially select the absorption and/or diffusion desired for the venue. Because some types of music benefit more from diffusion and other types of music benefit more from absorption, it is difficult to have a single room that accommodates all types of music. Typically, a compromise must be arrived at that will be good for many applications, but potentially not ideal for any single one.

### SUMMARY

The present embodiment represents a solution for the above-described issues by providing an acoustical treatment assembly that is adaptive between an absorption treatment and a diffusive-absorptive treatment. As such, a single assembly can serve different audio needs for different applications in the same location.

A first embodiment is an acoustical treatment assembly an acoustical treatment assembly an absorption panel and a diffusion panel that may be removably mounted to the absorption panel. The absorption panel has a first surface, an opposite second surface and a plurality of edge surfaces extending between the first surface and the second surface. The absorption panel hasing a plurality of channels defined in either or both of the second surface and the edge surfaces. Each channel has a seat spaced apart from the first surface and the second surface. Magnets are disposed in a corresponding one of the seats. The diffusion panel has a first surface, a second surface and a plurality of interior openings extend from and through the first surface and the second surface. The diffusion panel is formed of a material having a lower audio absorption than the absorption panel. Additional magnets are mounted on or below the second surface of the diffusion panel such that the first plurality of magnets and the second plurality of magnets cooperate to removably retain the diffusion panel adjacent to the absorption panel when the absorption panel is mounted on a wall with the first surface of the absorption panel substantially vertically oriented.

The adaptive assembly can thus be used in a room in the absorption configuration when the type of music or sound benefits from absorption, and can be used in the same room in the diffusion configuration when the type of music or sound benefits from a combination of absorption and diffusion.

The above-described features and advantages, as well as others, will become more readily apparent to those of ordinary skill in the art by reference to the following detailed description and accompanying drawings.

### BRIEF DESCRIPTION OF THE DRAWINGS

FIG. 1 shows a perspective view of a first embodiment of an acoustical treatment assembly according to an aspect of the invention;

FIG. 2A shows a bottom plan view of an absorption panel of the acoustical treatment assembly of FIG. 1;

FIG. 2B shows a bottom plan view of a diffusion panel of the acoustical treatment assembly of FIG. 1;

FIG. 3 shows a top plan view of the acoustical treatment assembly of FIG. 1 with the diffusion panel assembled or mounted on the absorption panel;

FIG. 4 shows a side cutaway view of the acoustical treatment assembly of FIG. 1 taken along line Iv-Iv of FIG. 3;

FIG. 5 shows a bottom plan view of the absorption panel with the cloth layer;

FIG. 6 shows a side cutaway view of an alternative embodiment of a acoustical treatment assembly.

### DETAILED DESCRIPTION

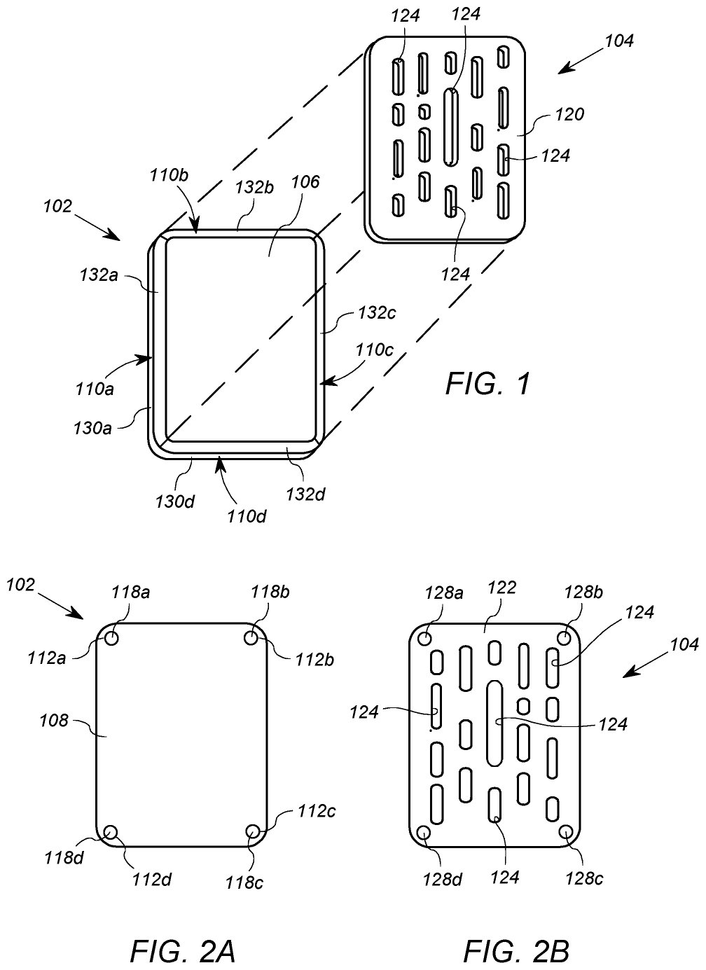

FIG. 1 shows a perspective view of an acoustical treatment assembly 100 according to a first embodiment of the invention, having an absorption panel 102 and a diffusion panel 104. The acoustical treatment assembly 100 has a first configuration primarily for sound absorption, and a second configuration has mixed properties of diffusion and absorption. In the first configuration, the absorption panel 102 is uncovered. In the second configuration, the diffusion panel 104 is mounted on and partially covers the absorption panel 102.

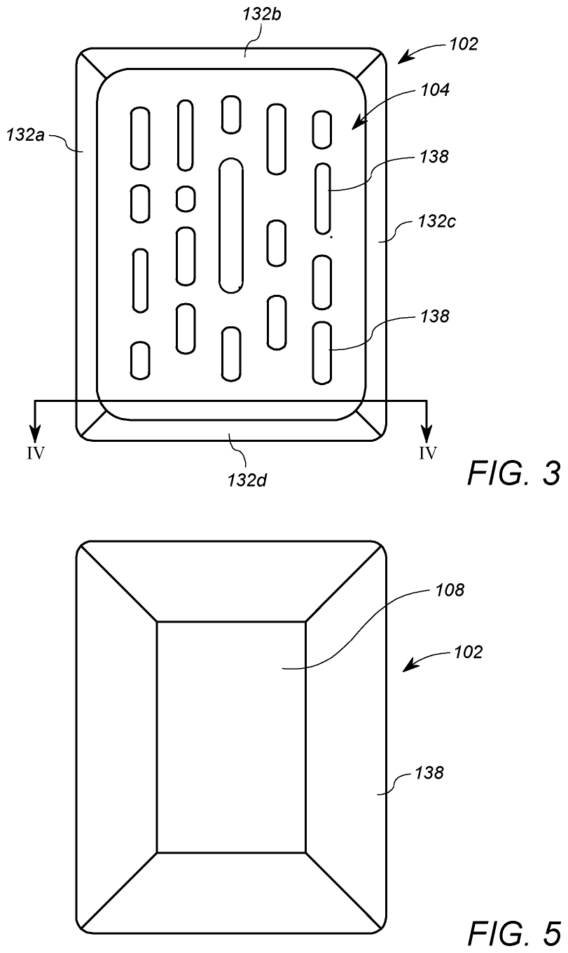

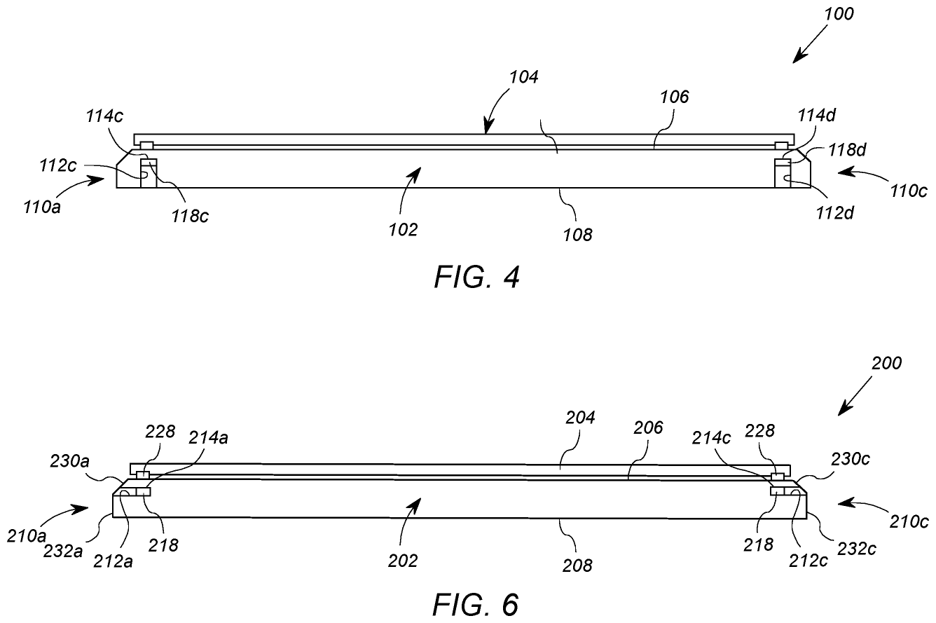

FIG. 1 shows a perspective view of the acoustical treatment assembly 100 with the absorption panel 102 and the diffusion panel 104 separated. FIG. 2A shows a bottom plan view of the absorption panel 102 and FIG. 2B shows a bottom plan view of the diffusion panel 104. FIG. 3 shows a top plan view of the acoustical treatment assembly 100 with the diffusion panel assembled or mounted on the absorption panel 102. FIG. 4 shows a cutaway view taken along line IV-IV of FIG. 3.

With simultaneous reference to FIGS. 1-4, acoustical treatment assembly 100 includes, in addition to the absorption panel 102 and the diffusion panel 104, a first plurality of magnets 118a-118d and a second plurality of magnets 128a-128d. As shown in FIG. 2, for example, each of the first plurality of magnets 118a-118d is affixed to the absorption panel 102, and each of the second plurality of magnets 128a-128d is affixed to the diffusion panel 104.

The absorption panel 102 has a first surface 106, an opposite second surface 108 and a plurality of edge surfaces 110a-110d extending between the first surface 106 (FIG. 1) and the second surface 108 (FIG. 2A). In this embodiment, the absorption panel 102 has a rectangular shape (meaning the first surface 106 and 108 have a rectangular shape), and may have rounded corners. However, it will be appreciated that the absorption panel 102 may have other shapes as dictated by aesthetic appeal and/or structural necessity.

The absorption panel 102 may suitably be formed from fiberglass, and may be chemically hardened in the area of the edge surfaces 110a-110d. The chemical hardening may suitably be accomplished by applying No Frame brand fiberglass edge coating available from www.metroflexsound.com. As will be discussed below, the chemical hardening on the edge surfaces 110a-110d helps provide strength to the fiberglass for the application of a fabric layer. It will be appreciated that other sound absorptive materials (or combination of materials) may be used.

In this embodiment, the absorption panel 102 has a beveled top edge. Specifically, each of the plurality of edge surfaces 110a-110d includes a first portion extending from and substantially perpendicular to the second surface 108 of the absorption panel 102, and a second portion extending in an angle inward from the first portion to the first surface 106 of the absorption panel 102. FIGS. 1 and 3 show first portions 130a, 130d of the corresponding edge surfaces 110a, 110d, and show the second portions 132a-132d of the corresponding edge surfaces 110a-110d. FIG. 4 shows the first portions 130a and 130c of the corresponding edge surfaces 110a and 110c.

As shown in FIGS. 2A and 4, the absorption panel 102 has a plurality of channels 112a-112d defined in the second surface 108. Each of the channels 112a-112d extends from the second surface 108 in a direction toward the first surface 106, but terminates short of the first surface by approximately 0.125″ to 0.5″. The channels 112a-112d in this embodiment are disposed proximate the corners of the absorption panel, as shown in FIG. 2A.

As shown in FIG. 4, the channel 112c terminates in a seat 114c that is disposed between and is spaced apart from the first surface 106 and the second surface 108. The channel 112d similarly terminates in a seat 114d that is spaced apart from the first surface 106 and the second surface 108. The magnet 118c is disposed and secured in the seat 114c, and the magnet 118d is disposed and secured in the seat 114d. It will be appreciated that the seats 114c-114d may suitably have the same general cross-sectional shape as the remainder of the corresponding channel, or may be modified to fit the magnets 118c-118d more precisely than the other parts of the channels 112c, 112d. The other magnets 118a and 118b are likewise secured in similar seats within respective channels 112a and 112b.

Each of the magnets 118a-118d may be any suitable permanent magnet, such as disk or ring magnet, that has the magnetic strength sufficient to cooperate with the other magnets, and the second plurality of magnets 128a-128d on the diffusion panel 104 (discussed further below), to hold the diffusion panel in place on the first surface 106 of the absorption panel 102 when the absorption panel 102 is mounted on a vertical wall (or ceiling), not shown.

The diffusion panel 104 has a first surface 120, a second surface 122, and a plurality of interior openings 124 that extend from and through the first surface 120 and the second surface 122. The openings 124 are configured such that when the diffusion panel 104 is mounted on the absorption panel 102, portions of the absorption panel 102 are directly exposed to incident sound waves via the openings 124, while other portions of the absorption panel 102 are covered by diffusion panel. The diffusion panel 104 is formed of a material having a lower audio absorption than the absorption panel 102. By way of non-limiting example, the diffusion panel 104 may be formed primarily or completely of wood.

Each of the second plurality of magnets 128a-128d is mounted on or below the second surface 122 of the diffusion panel 104, such that the first plurality of magnets 118a-118d and the second plurality of magnets 128a-128d cooperate to removably retain the diffusion panel 104 adjacent to the absorption panel 102 when the absorption panel 102 is mounted on a wall with the first surface 104 of the absorption panel 102 substantially vertically oriented. To this end, the magnets 128a-128d are positioned such that they align with the first plurality of magnets 118a-118d when the diffusion panel 104 is mounted on the absorption panel 102. While this embodiment employs four magnets on each of the absorption panel 102 and diffusion panel 104, more or fewer magnets may be employed as needed to support or help support the diffusion panel 104 on the absorption panel 102.

The second surface 122 of the diffusion panel 104 is substantially planar (except for the openings 124), but may include recesses for partial or full inset the second plurality of magnets 128a-128d. In other embodiments, the second surface 122 is substantially planar (except for openings 124), and the entire thickness of the magnets 128a-128d extends outward from the planar second surface 122. In any event, it is preferable that the second surface 122 be slightly spaced apart from the first surface 106 of the absorption panel when the diffusion panel 104 is mounted.

The sizes and shapes of the openings 124 may vary, both as a visual aesthetic and for acoustic reasons. Because the openings 124 affect diffusion, there is always a possibility that uniform spacing, size and shape would undesirably cause disparate impact for specific frequencies in the audible spectrum. By varying the size and/or shape of the openings 124, the diffusion effects are spread across multiple frequencies.

The absorption panel 102 may further include a fabric layer 138, not shown in FIG. 1, stretched over at least the first surface 106. To this end, FIG. 5 shows a rear plan view of the absorption panel 102 with the fabric layer 138. The fabric layer 138 extends over the first surface 106 and side edges 110a-110d (see FIG. 3) and is glued, stapled or otherwise affixed to the second surface 108. The fabric layer 138 provides both aesthetic and functional advantages to the absorption panel.

In use, the absorption panel 102 (with the cloth layer 138) may be mounted on a wall in a sound studio and/or other room, hall or assembly area. The diffusion panel 104 is dismounted from the absorption panel 102 for situations in which maximum absorption is desired. In situations in which less absorption and more diffusion is desired, the diffusion panel 104 is mounted to the absorption panel 102 on the wall by aligning the magnets 128a-128d of the diffusion panel 104 with the magnets 118a-118d of the absorption panel 102. It will be appreciated that in many cases the magnets 128a-128d can align with the magnets 118a-118d in multiple orientations of the diffusion panel 104. As long as the magnets 118a-118d and magnets 128a-128d are arranged symmetrically in one or two dimensions, the diffusion panel 104 may be mounted in multiple ways, as desired for either acoustic or aesthetic reasons.

FIG. 6 shows a cross-section of an alternative embodiment of an acoustical treatment assembly 200. The acoustical treatment assembly 200 includes an absorption panel 202, a diffusion panel 204, a first plurality of magnets 218, and a second plurality of magnets 228. The diffusion panel 204 may suitably be identical in structure to the diffusion panel 104 of FIGS. 1-4. Likewise, the magnets 218, 228 may be identical in structure to the magnets 118a-218d and 128a-228d.

The absorption panel 204 has a first surface 206, an opposite second surface 208 and a plurality of edge surfaces, of which only surfaces 210a, 210c are visible in FIG. 6. The edge surface 210a, 210c extend between the first surface 206 and the second surface 208. In this embodiment, the absorption panel 202 has the same rectangular shape as the absorption panel 102 of FIGS. 1-5. However, it will be appreciated that the absorption panel 202 may have other shapes as dictated by aesthetic appeal and/or structural necessity. The absorption panel 202 may suitably be formed from fiberglass, and have chemically hardened edge surface similar to the panel 102.

Like the absorption panel 102 of FIGS. 1-5, the absorption panel 202 has a beveled top edge. Thus, the edge surface 210a includes a first portion 230a extending from and substantially perpendicular to the second surface 208 of the absorption panel 202, and a second portion 232a extending in an angle from the first portion 230a to the first surface 206 of the absorption panel 202. The other edge surfaces (including surface 210c) of the absorption panel 202 may suitably have identical structures.

As shown in FIG. 6, the absorption panel 202 has a plurality of channels 212a and 212c defined in respective edge surfaces 210a, 210c. The channel 212a extends from the respective edge surface 210a in a direction toward the opposite edge surface 210c, and terminates in a seat 214a that is disposed between and is spaced apart from the first surface 206 and the second surface 208. The seat 214a may have the same position as the seat 114a of FIG. 4. In this embodiment, however, the channel 212a extends laterally to the seat 214a from the edge surface 210a, and more specifically, at least in part from the second portion 232a of the edge surface 210a. In a similar manner, the channel 212c extends from the edge surface 210c and terminates in a seat 214c that is disposed between and spaced apart from the surfaces 206, 208. The absorption panel 202 may suitably have additional channels in the same positions of channels 112b and 112d, that have an analogous structure.

While it is possible to also form the channels the first surface 106 of the absorption panel 102, such design has the potential disadvantage of visually perceptible discontinuities at the location of the magnets and channels. In particular, although the first surface 106 is typically covered by a cloth layer 138, the discontinuity of holes in the first surface 106 can be perceived. Because the acoustical treatment assembly 100 is also intended to form a pleasing aesthetic wall mounting, the crisp, clean first surface 106 of the absorption panel 102 would lose much of its appeal with such discontinuities. It is noted that the embodiment of FIG. 6 may also show discontinuities, but they are less perceptible away from the relatively continuous first surface 106.

Another aspect of the invention is a method constructing an adaptable acoustical assembly. First, an absorption panel (e.g. panel 102, 202) is provided to have a first surface, an opposite second surface and a plurality of edge surfaces extending between the first surface and the second surface, the absorption panel having a plurality of channels defined in at least one of group consisting of the second surface and one or more of the plurality of edge surfaces, each channel having a seat spaced apart from the first surface and the second surface. By way of example, the method could include providing the panel 102 or the panel 202 discussed above.

To create the absorption panel 102, channels 112a-112d may be created in the fiberglass sheet via machining or drilling from the second surface 108 of the fiberglass sheet.

Thereafter, a first plurality of magnets are disposed in a corresponding one of the seats. In the embodiment of the panel 102, the magnets 114a-114d are advanced through the corresponding channels 112a-112d in a direction from the second surface 108 toward the first surface 106, until they reach the corresponding seat. The magnets may be glued, friction fit, or otherwise secured in their seats.

Once the magnets 114a-114d are in place, the cloth layer 138 is assembling the first surface 106 and edge surfaces 110a-110d, secured to the back surface 108.

A diffusion panel is also provide, the diffusion panel having a first surface, a second surface and a plurality of interior openings extend from and through the first surface and the second surface, the diffusion panel formed of a material having a lower audio absorption than the absorption panel, the diffusion panel having a second plurality of magnets mounted on or below the second surface of the diffusion panel such that the first plurality of magnets and the second plurality of magnets cooperate to removably retain the diffusion panel adjacent to the absorption panel when the absorption panel is mounted on a wall with the first surface of the absorption panel substantially vertically oriented. The diffusion panel may suitably be the diffusion panel 104.

It will be appreciated that the above described embodiments are merely illustrative, and that those of ordinary skill in the art may readily devise their own implementations and modifications that incorporate the principles of the invention and fall within the spirit and scope thereof.

What is claimed is:

1. An acoustical treatment assembly comprising:
an absorption panel having a first surface, an opposite second surface and a plurality of edge surfaces extending between the first surface and the second surface, the absorption panel having a plurality of channels defined in at least one of group consisting of the second surface and one or more of the plurality of edge surfaces, each channel having a seat spaced apart from the first surface and the second surface;
a first plurality of magnets, each of the first plurality of magnets disposed in a corresponding one of the seats;
a diffusion panel having a first surface, a second surface and a plurality of interior openings extend from and through the first surface and the second surface, the diffusion panel formed of a material having a lower audio absorption than the absorption panel; and
a second plurality of magnets mounted on or below the second surface of the diffusion panel such that the first plurality of magnets and the second plurality of magnets cooperate to removably retain the diffusion panel adjacent to the absorption panel when the absorption panel is mounted on a wall with the first surface of the absorption panel substantially vertically oriented.

2. The acoustical treatment assembly of claim 1, wherein at least one of the plurality of channels extends from the second surface of the absorption panel in a direction toward the first surface of the absorption panel.

3. The acoustical treatment assembly of claim 1, wherein at least one of the plurality of channels extends from a first edge surface of the plurality of edge surfaces in a direction toward a second edge surface of the plurality of edge surfaces.

4. The acoustical treatment assembly of claim 3, wherein the first edge surface includes a first portion extending from and substantially perpendicular to the second surface of the absorption panel, and a second portion extending in an angle from the first portion to the first surface of the absorption panel.

5. The acoustical treatment assembly of claim 4, wherein at least a part of the at least one of the plurality of channels extends through a part of the second portion of the first edge surface.

6. The acoustical treatment assembly of claim 1, wherein the first edge surface includes a first portion extending from and substantially perpendicular to the second surface of the absorption panel, and a second portion extending in an angle from the first portion to the first surface of the absorption panel.

7. The acoustic treatment assembly of claim 6, wherein the absorption panel is formed from fiberglass and wherein the acoustic treatment assembly further comprises at least one layer of fabric covering at least the first surface of the absorption panel and the at least one edge surface of the absorption panel.

8. The acoustic treatment assembly of claim 1, wherein the plurality of interior openings includes openings of a plurality of sizes and/or shapes.

9. The acoustic treatment assembly of claim 1, where a first surface of the magnet nearest the first surface of the absorption panel is spaced apart from the first surface of the absorption panel by 0.125 to 0.25 inches.

10. A method of making an acoustic treatment assembly, comprising:
a) providing an absorption panel having a first surface, an opposite second surface and a plurality of edge surfaces extending between the first surface and the second surface, the absorption panel having a plurality of channels defined in at least one of group consisting of the second surface and one or more of the plurality of edge surfaces, each channel having a seat spaced apart from the first surface and the second surface;
b) disposing a first plurality of magnets in a corresponding one of the seats; and
c) providing a diffusion panel having a first surface, a second surface and a plurality of interior openings extend from and through the first surface and the second surface, the diffusion panel formed of a material having a lower audio absorption than the absorption panel, the diffusion panel having a second plurality of magnets mounted on or below the second surface of the diffusion panel such that the first plurality of magnets and the second plurality of magnets cooperate to removably retain the diffusion panel adjacent to the absorption panel when the absorption panel is mounted on a wall with the first surface of the absorption panel substantially vertically oriented.

11. The method of claim 10, wherein step b) further comprises advancing a first magnet of the first plurality of magnets through a first channel of the plurality of channels in a direction from the second surface of the absorption panel to the first surface of the absorption panel.

12. The method of claim 11, further comprising:
after step b), assembling at least one cloth layer over at least the first surface of the absorption panel and the at least one edge surface of the absorption panel.

13. The method of claim 10, wherein step b) further comprises advancing a first magnet of the first plurality of magnets through a first channel of the plurality of channels in a direction from a first of the least one edge surfaces.

14. The method of claim 13, further comprising:
after step b), assembling at least one cloth layer over at least the first surface of the absorption panel and the first of the at least one edge surface of the absorption panel.
